(19) United States
(12) Patent Application Publication
(10) Pub. No.: US 2026/0214437 A1
(43) Pub. Date: Jul. 23, 2026

(54) Method of Encrypting VoIP Communications

(71) Applicant: Private Tech, Inc., Arlington, VA (US)

(72) Inventors: John McKinstry Doyle, Arlington, VA (US); Stephen James Dowhy, Arlington, VA (US); Benny Tran, Arlington, VA (US)

(21) Appl. No.: 19/445,501

(22) Filed: Jan. 10, 2026

Related U.S. Application Data
(60) Provisional application No. 63/743,787, filed on Jan. 10, 2025.

(51) Int. Cl. H04W 12/033; H04L 9/08

(52) U.S. Cl. CPC H04W 12/033; H04L 9/0866

(57) ABSTRACT

Disclosed is a method of encrypting VoIP communications including generating a public key and a private key associated with a mobile subscriber, storing the private key on a mobile device of the mobile subscriber, receiving, by a mobile network, a voice call for the mobile subscriber, generating an encrypted voice data packet by encrypting a voice data packet with the public key, sending the encrypted voice data packet to the mobile device, decrypting the encrypted voice data packet using the private key device to yield the voice data packet.

### BACKGROUND OF THE INVENTION

This application is a continuation-in-part of U.S. Application 63/743,787 filed January 10, 2025 the entirety of which is hereby incorporated by reference.

### FIELD OF THE INVENTION

The embodiments of the invention relate to Voice over Internet Protocol (VoIP), and more particularly, to a method of providing encrypted communications over VoIP. Although embodiments of the invention are suitable for a wide scope of applications, it is particularly suitable for encrypting VoIP communications when roaming on untrusted networks.

### Discussion of the Related Art

Voice over Internet Protocol (VoIP) is a technology that enables voice communications to be transmitted over Internet Protocol (IP) networks rather than traditional circuit-switched telephone networks. In a typical VoIP system, analog voice signals are converted into digital data packets that can be transmitted over IP networks, including the public Internet and private data networks.

The basic operation of VoIP involves several key processes. First, when a user speaks into a VoIP-enabled device, the analog voice signal is captured by a microphone and converted into a digital format through an analog-to-digital converter. The digital voice data is then compressed using audio codecs to reduce bandwidth requirements while maintaining acceptable voice quality. The compressed voice data is subsequently packetized into small data packets that include header information containing source and destination addresses, sequence numbers, and timing information.

These voice data packets are transmitted across IP networks using transport protocols, typically the Real-time Transport Protocol (RTP) for carrying the actual voice data and the Session Initiation Protocol (SIP) for establishing, maintaining, and terminating voice sessions. SIP handles the signaling aspects of VoIP calls, including call setup, call routing, and call teardown, while RTP handles the actual delivery of voice packets in real-time.

At the receiving end, the voice data packets are collected, reordered if necessary based on sequence numbers, decompressed, and converted back into analog signals that can be played through a speaker. To compensate for network jitter and packet loss, VoIP systems typically employ jitter buffers that temporarily store incoming packets to smooth out variations in packet arrival times.

VoIP communications can occur between various types of endpoints, including dedicated VoIP phones, softphone applications running on computers or mobile devices, and traditional telephones connected through VoIP adapters or gateways. VoIP gateways serve as bridges between VoIP networks and the Public Switched Telephone Network (PSTN), enabling VoIP users to communicate with users on traditional telephone networks.

### 4G VoIP Encryption

Voice over LTE (VoLTE) represents the standard method for transmitting voice calls over 4G LTE networks, replacing the traditional circuit-switched voice infrastructure with an all-IP architecture. In VoLTE implementations, voice traffic is transmitted as IP packets over the LTE data network, utilizing the IP Multimedia Subsystem (IMS) for session management and call control.

The security architecture for VoLTE calls incorporates multiple layers of protection. At the radio access network level, LTE employs the SNOW 3G, AES, and ZUC encryption algorithms to protect data transmitted over the air interface between the mobile device and the base station. This encryption is negotiated during the device authentication process and protects voice packets as they traverse the wireless link.

Within the IMS core network, SIP signaling for VoLTE calls can be protected using IPsec tunnels established between the mobile device and the Proxy Call Session Control Function (P-CSCF). This IPsec protection can secure the signaling path and prevents unauthorized access to call setup information. The actual voice media in VoLTE calls can be protected using SRTP, although implementation varies among network operators.

### 5G VoIP Encryption

Fifth-generation (5G) wireless networks introduce enhanced security mechanisms for voice communications while maintaining compatibility with the IP Multimedia Subsystem (IMS) architecture used in VoLTE. Voice over New Radio (VoNR), also known as Voice over 5G, represents the native voice service for 5G standalone networks and incorporates several security improvements over its 4G predecessor.

At the radio access network level, 5G employs the 5G-AKA (Authentication and Key Agreement) protocol for mutual authentication between the mobile device and the network. The 5G security architecture supports 128-bit and 256-bit encryption using the NEA (5G Encryption Algorithm) family, which includes NEA1 based on SNOW 3G, NEA2 based on AES, and NEA3 based on ZUC. These algorithms protect user plane traffic, including voice data, as it traverses the air interface between the user equipment and the 5G base station.

The 5G core network architecture introduces the Security Edge Protection Proxy (SEPP) to secure signaling between different network operators at roaming interfaces. Additionally, 5G networks implement the Service Based Architecture (SBA), where network functions communicate using HTTP/2 over TLS, providing encryption for control plane communications within the core network. For voice media protection in 5G networks, SRTP remains the standard mechanism for encrypting voice streams within the IMS framework.

### Problems of the Related Art

Despite the availability of these encryption technologies, end-to-end encryption of VoIP calls remains challenging in many scenarios. When VoIP calls traverse network boundaries, pass through media gateways, or connect to the PSTN, encryption is often terminated at intermediate points, leaving portions of the call path unprotected. Additionally, many legacy VoIP systems and endpoints do not support encryption, and interoperability requirements may force calls to fall back to unencrypted modes.

This problem is particularly acute in mobile network environments where voice calls may originate from or terminate at devices that lack native encryption capabilities. When a VoIP call is placed from an encrypted endpoint to a mobile subscriber, the encryption typically terminates at the boundary between the VoIP network and the mobile network infrastructure. From that point forward, the voice data traverses the mobile network in an unencrypted or minimally protected state, exposing the communication to potential interception by malicious actors who have gained access to network infrastructure or through man-in-the-middle attacks.

Furthermore, the heterogeneous nature of modern telecommunications networks exacerbates these security vulnerabilities. A single voice call may traverse multiple network domains, including enterprise VoIP systems, Internet service provider networks, VoIP peering exchanges, mobile carrier networks, and potentially the legacy PSTN. Each transition between network domains represents a potential point where encryption may be stripped, downgraded, or simply not supported. Media gateways that convert between different protocols or network types frequently decrypt incoming encrypted streams to perform transcoding or protocol conversion, then may or may not re-encrypt the outgoing stream depending on the capabilities of the destination network.

The lack of a unified key management infrastructure across different network operators and service providers further complicates the implementation of end-to-end encryption. Even when both endpoints of a call support encryption, establishing a secure key exchange across multiple intermediate networks controlled by different entities presents significant technical and administrative challenges. Existing key exchange mechanisms such as ZRTP require direct communication between endpoints, which may not be possible when calls are routed through network elements that modify or terminate media streams.

The encryption provided by VoLTE has significant limitations from an end-to-end security perspective. The encryption terminates at network boundaries, meaning that voice traffic is decrypted within the carrier’s core network infrastructure before being re-encrypted for transmission to the destination. This architecture creates trust dependencies on the network operator and exposes voice communications to potential interception at points within the carrier infrastructure. Furthermore, when VoLTE calls connect to external networks, including other mobile carriers, VoIP providers, or the PSTN, the encryption protections may not extend across these interconnection points, leaving portions of the call path vulnerable to interception.

Similar to VoLTE, the encryption protections in VoNR are primarily focused on protecting communications within the network operator’s domain. Voice traffic is typically decrypted at network boundaries, and calls connecting to external networks, legacy systems, or the PSTN face the same end-to-end encryption challenges present in 4G networks. The 5G architecture does not inherently solve the problem of maintaining encryption when voice calls traverse multiple network domains controlled by different operators or service providers.

Thus, there is a need for providing a VoIP system that provides encryption across network boundaries, including for SIP headers, message contents, and voice data.

### SUMMARY OF THE INVENTION

Accordingly, embodiments of the invention are directed to a method of encrypting VoIP communications that substantially obviates one or more of the problems due to limitations and disadvantages of the related art.

An object of embodiments of the invention is to provide encryption of VoIP communications across network boundaries;

Another object of embodiments of the invention is to provide encryption of VoIP communications when using a roaming network;

Yet another object of embodiments of the invention is to provide end to end encryption of VoIP communications;

Still another object of embodiments of the invention is to provide encryption of VoIP communications over intermediate networks.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, method of encrypting VoIP communications includes generating a public key and a private key associated with a mobile subscriber, storing the private key on a mobile device of the mobile subscriber, receiving, by a mobile network, a voice call for the mobile subscriber, generating an encrypted voice data packet by encrypting a voice data packet with the public key, sending the encrypted voice data packet to the mobile device, decrypting the encrypted voice data packet using the private key device to yield the voice data packet.

In another aspect, method of encrypting VoIP communications includes generating a public key and a private key associated with the first mobile device, storing the private key on a mobile device of the mobile subscriber, requesting, by a second mobile device, the public key, initiating, by the second mobile device, a digital voice call with the first mobile device, generating an encrypted voice data packet from an unencrypted voice data packet of the digital voice call using the public key, sending the encrypted voice data packet to a mobile network by the second mobile device, sending the encrypted voice data packet to the first mobile device by the mobile network, and decrypting the encrypted voice data packet using the private key on the first mobile device.

In yet another aspect, method of encrypting VoIP communications includes receiving, by the subscriber network, a voice call for the mobile device, packetizing the voice call into a plurality of unencrypted data packets, encrypting the unencrypted data packets into a plurality of encrypted data packets using a private key of the mobile device, sending the plurality of encrypted data packets to the roaming network, receiving, by the mobile device, the plurality of encrypted data packets, decrypting, but the mobile device, the plurality of encrypted data packets into a decrypted plurality of data packets using a private key of the mobile device, and assembling the decrypted plurality of data packets into a voice data stream.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a diagram of a VoIP communications network according to an exemplary embodiment of the invention;

FIG. 2 is a flow chart of end-to-middle encryption according to an exemplary embodiment of the invention; and

FIG. 3 is a flow chart of end-to-end encryption according to an exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

VoIP encryption algorithms of the related art generally rely on the 4G/5G specifications. The encryption strength of these specifications is generally robust, but relies on inherent trust of mobile network operators. For example, under the related art, VoIP communications can be encrypted from the subscriber device to the network operator, but can be decrypted by the network operator for processing and further transmission. A nefarious actor or a state actor with access to the network operator could gain access to VoIP communications if they had access to the network operator. This risk is particularly acute for high value persons such as diplomats, military, and government officials roam on foreign networks when traveling in other countries where communications traffic is routed through a roaming network operator before being sent to the subscriber network operator. Embodiments of the invention provide a method of encrypting communications between the subscriber device and the subscriber network (end-to-middle) or between the subscriber device and the other caller (end-to-end) thereby protecting communications over vulnerable or untrusted network segments.

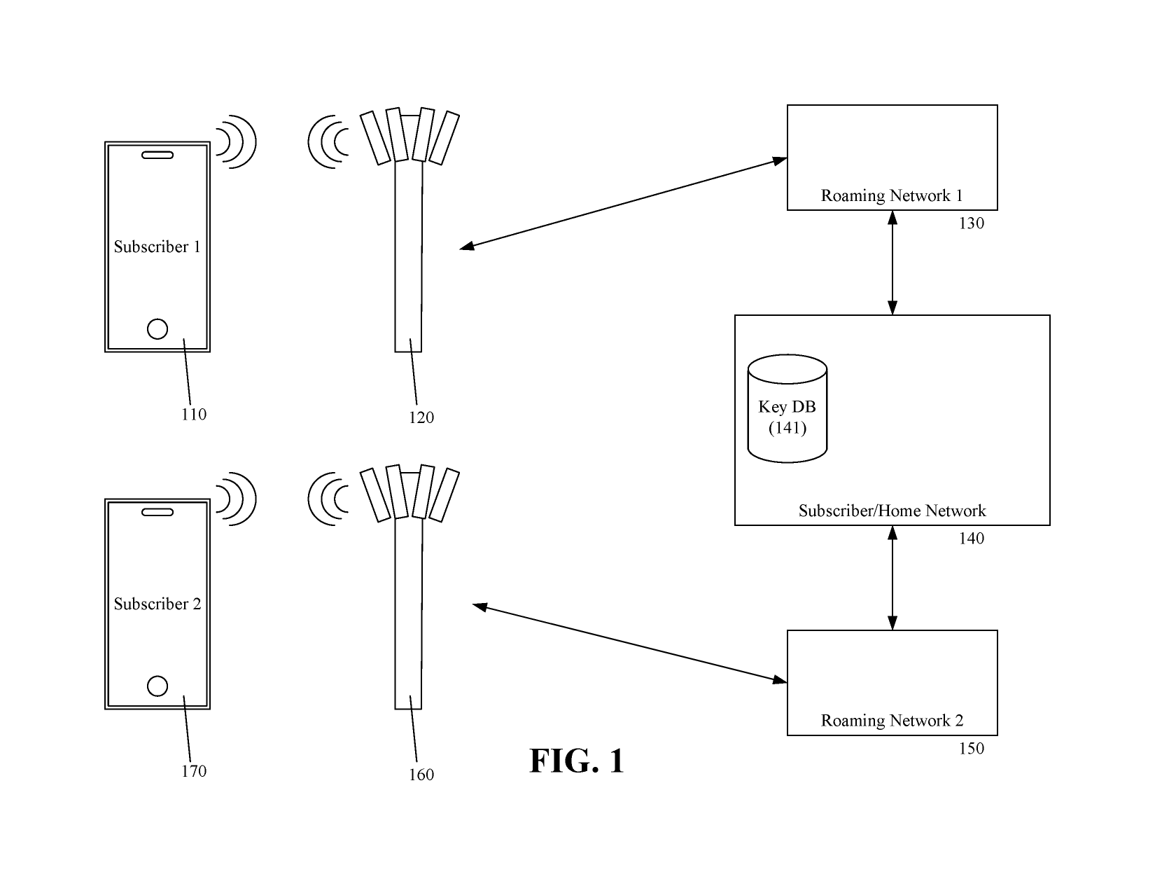

FIG. 1 is a diagram of a VoIP communications network according to an exemplary embodiment of the invention. FIG. 1 illustrates an exemplary communications path between two mobile device that share a home network, but are roaming on different networks. As shown in FIG. 1, a VoIP communications network can include a first subscriber 110, a first tower 120, a first roaming network operator 130; a subscriber network operator 140, a second roaming network operator 150, a second tower 160, and a second subscriber 170. The subscriber network can have a key database 141.

Embodiments of the invention provide for end-to-middle encryption between the subscriber devices 110 and 170 and the home network 140. Alternatively, embodiments of the invention provide for end-to-end encryption between the subscriber devices 110 and 170. In contrast, under current 4G/5G specifications, communications between the first subscriber 110 and the second subscriber 170 would be subject to decryption by the first roaming network operator 130 and the second roaming network operator 150.

In the communications network of FIG. 1, VoIP data packets can be sent by the first subscriber 110 wirelessly to the first tower 120. The first tower 120 can, in turn forward the packets to a roaming network 130. The roaming network 130 can forward the packets to the subscriber’s network 140. The subscriber’s network 140 can forward the packets to a second roaming network 150 where the second subscriber is registered. The second roaming network 150 can forward the packets to a second tower 160 where the second subscriber 170 is known to connected. The second tower 160 can wirelessly transmit the data packets to the second subscriber 170 thereby completing the sending of VoIP data packets from the first subscriber 110 to the second subscriber 170.

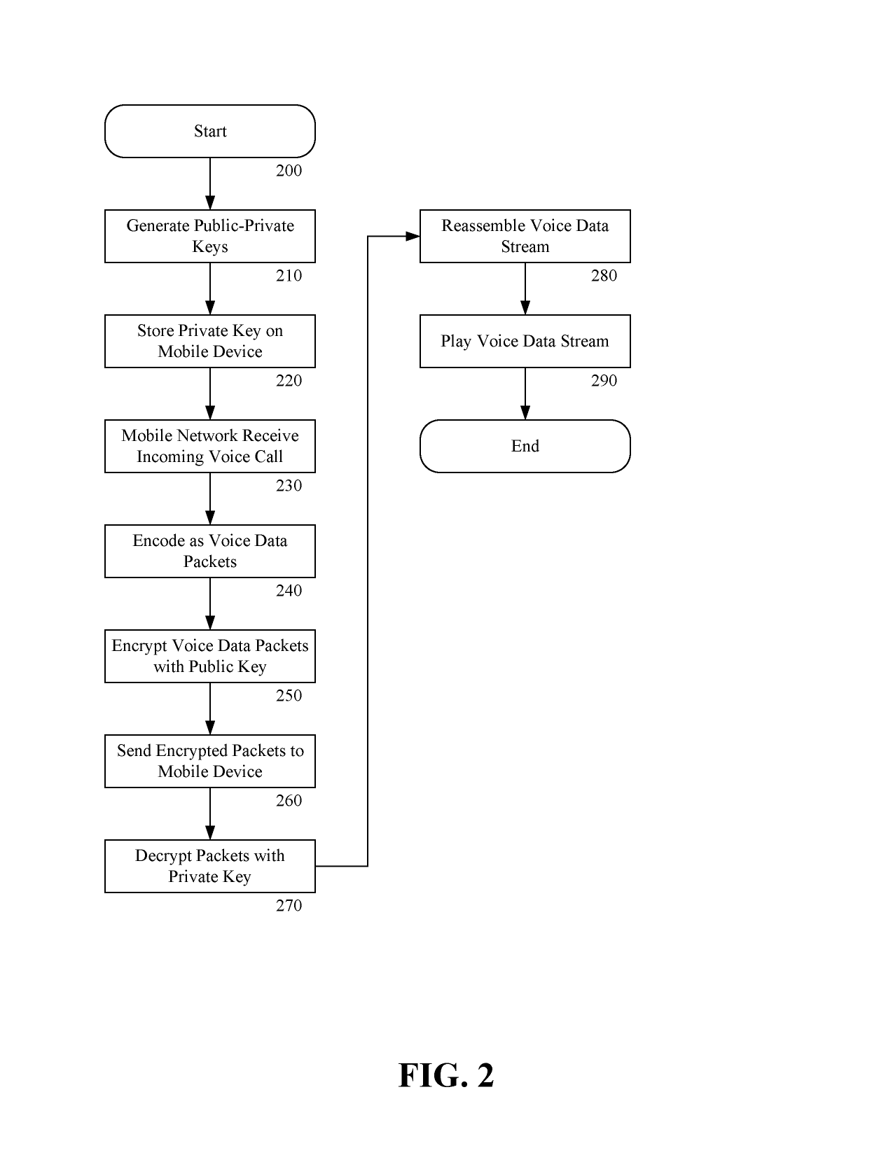

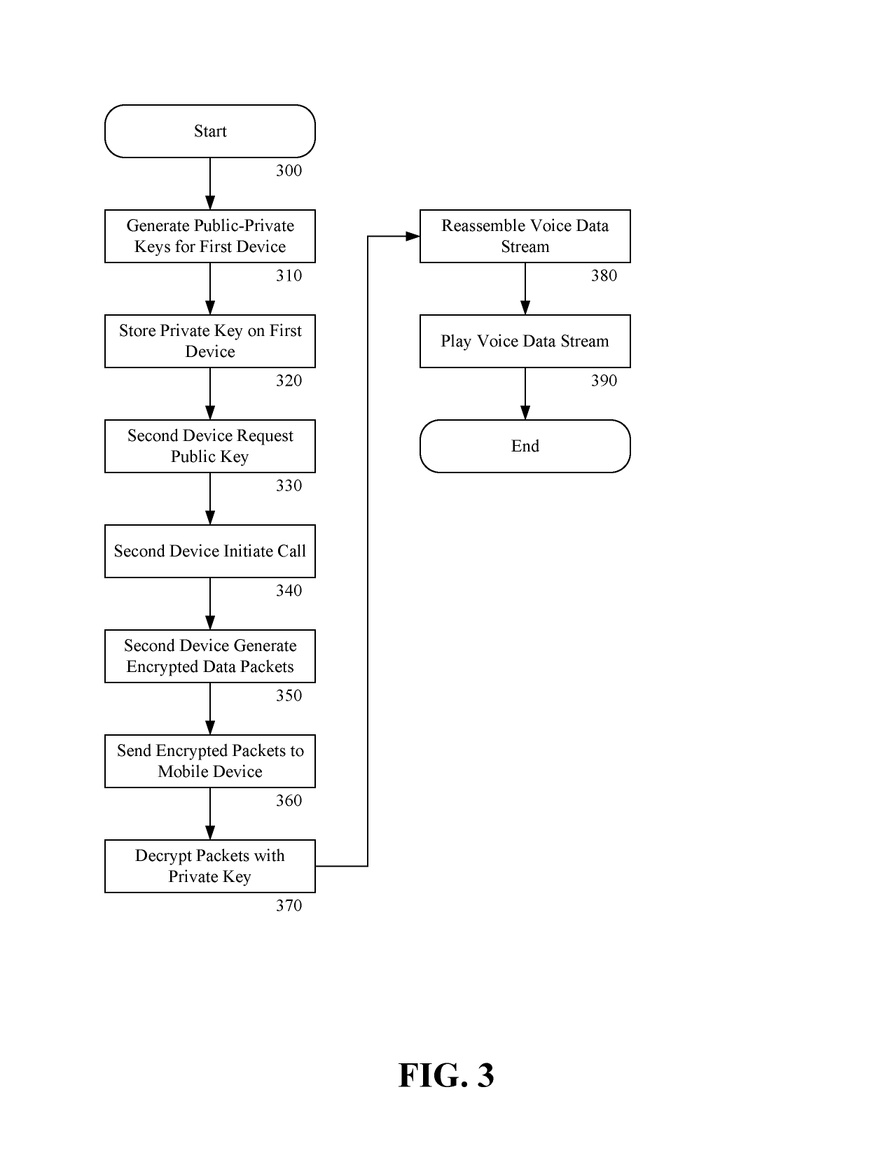

As will be discussed in greater detail in conjunction with FIG. 2 and FIG. 3, each subscriber device 110 and 170 can have a unique public key and a unique private key. The private keys can be stored on the subscriber devices. The public keys can be stored in a public key database 141 on the subscriber network 140. The subscriber network can also have a public key and private key. The public key of the subscriber network 140 can be stored in the key database 141. Communications between a subscriber device 110 or 170 and the subscriber network 140 can be encrypted with the public key of the intended recipient. Subscriber devices 110 and 170 can access the key database 141 to lookup public keys of prospective communication counterparties. The subscriber devices can cache previously retrieved public keys. Subscriber devices 110 and 170 can be preloaded with public keys of anticipated communication partners.

In greater detail, when first subscriber 110 and the second subscriber 170 are on the same subscriber network 140 and desire to undertake encrypted VoIP communications, the first subscriber 110 can request the public key of the second subscriber 170 from the key database 141 on the home network 140. Communications sent from the first subscriber 110 to the second subscriber 170 can be encrypted with the public key of the second subscriber 170. Conversely, for communications from the second subscriber 170 to the first subscriber 110, the second subscriber 170 can request the public key of the first subscriber 110 from the key database 141 on the home network 140. Communications sent from the second subscriber 170 to the first subscriber 110 can be encrypted with the public key of the first subscriber 110. Each of the first subscriber 110 and the second subscriber 170 can decrypted received encrypted communications with their respective private keys. In this way, communications between the first subscriber 110 and the second subscriber 170 are encrypted end-to-end. In alternative embodiments of the invention, the first subscriber 110 and the second subscriber 170 can use initially encrypt communications using their respective public keys, exchange a session key, and subsequently continue communications with symmetric key encryption using the exchanged session key.

In an alternative embodiment of the second subscriber 170 is does not support encryption as previously described. The second subscriber 170 may not support the previously described end-to-end encryption if, for example, the second subscriber is a subscriber to a different network or there is a technical failure in the key retrieval. In these instances, the first subscriber 110 may encrypt VoIP communications with the public key of the subscriber network 140 instead of the second subscriber 170. When the subscriber network receives these encrypted communications, it can decrypt them with its own public key and forward the VoIP packets on to the second subscriber 170 in accordance with the related art. In reverse, unencrypted VoIP packets received by the subscriber network 140 from the second subscriber 170 for the first subscriber 110 can be encrypted by the subscriber network 140 using the public key of the first subscriber 110. In this way, communications are at least encrypted between the first subscriber 110 and the subscriber network 140 (end-to-middle) and provides security against malicious actors that may have access to the roaming network operator 130. End-to-middle encryption may be sufficient where the first subscriber 110 is located in an adversarial country and the second subscriber 170 is located in a non-adversarial country where communications are unlikely to be surveilled.

FIG. 2 is a flow chart of end-to-middle encryption according to an exemplary embodiment of the invention. End-to-middle encryption may be implemented when one party to a VoIP call does not implement the novel encryption methods of the present invention. In these cases, VoIP communications are encrypted between the subscriber device and the subscriber network, but may be unencrypted or sent in accordance with the related art for communications between the subscriber network and the other party to the VoIP session. As shown in FIG. 2, end-to-middle encryption can include generating public/private keys 210, storing private keys on a mobile device 220, receiving an incoming call by the mobile network 230, encoding the incoming call as voice data packets 230, encrypting the voice data packets with the public key of the mobile device 240, sending the encrypted packets to the mobile device 250, decrypting the encrypted packets with the private key 260, assembling a voice data stream from the decrypted packets 270, and playing the voice data stream 280.

In step 210, a public-private key pair can be generated upon initial provisioning of a mobile device. Initial provisioning of a mobile device can include setting up the mobile device for the first time on the subscriber network wherein the mobile device is registered with the subscriber network and authorized to access network services such as voice and data. During registration, the device can transmit its International Mobile Equipment Identity (IMEI) and the International Mobile Subscriber Identity (IMSI) stored on the Subscriber Identity Module (SIM) card to the network infrastructure.

The provisioning process can also establish the device's capabilities and service entitlements, including supported frequency bands, data service tiers, messaging permissions, and supplementary service subscriptions. For devices implementing embodiments of the present invention, the provisioning phase can additionally include the generation of cryptographic key pairs.

Many methods of asymmetric key encryption are known and can be used with the present invention and, accordingly, the invention is not limited to a specific encryption algorithm. Asymmetric key encryption, also known as public key cryptography, employs mathematically related key pairs consisting of a public key that may be freely distributed and a private key that must remain confidential to its owner. Unlike symmetric encryption schemes where the same key is used for both encryption and decryption operations, asymmetric algorithms enable secure communication between parties who have not previously exchanged secret key material, making them particularly suitable for establishing secure channels over untrusted networks such as cellular messaging infrastructure.

The RSA (Rivest-Shamir-Adleman) algorithm is one such asymmetric encryption algorithm and represents one of the most widely deployed asymmetric encryption systems. The RSA algorithm derives its security from the computational difficulty of factoring the product of two large prime numbers. Elliptic Curve Cryptography (ECC) provides an alternative asymmetric encryption framework based on the algebraic structure of elliptic curves over finite fields. ECC offers equivalent security to RSA with substantially smaller key sizes, making it particularly advantageous for resource-constrained mobile devices where computational efficiency and storage limitations are relevant considerations. A 256-bit ECC key provides security comparable to a 3072-bit RSA key while requiring less computational overhead for key generation, encryption, and decryption operations.

In step 220, the private key generated in step 210 can be saved on the mobile device. The private key can be used to decrypt communications previously encrypted with the corresponding public key. The public key can be stored on the subscriber network. The public key stored on the subscriber network can be used for encrypting communications to be sent to the mobile device.

The public key can be shared or published. In some embodiments of the invention, third parties may desire initiate VoIP communications to a mobile device on the subscriber network. In these embodiments, these third parties can access the public key for purposes of encrypting VoIP communications. In some embodiments, copies of the public keys are shared and third parties such as other networks or providers can maintain a database of public keys on the subscriber network. In other embodiments, the public keys are made available to third parties via an API so that the third parties may access public encryption keys for a particular subscriber whenever they are needed. The third party can optionally cache encryption keys received from the subscriber network. The third party can delete encryption keys after a preset interval to avoid unchecked cache growth. The third party can re-request encryption keys after a preset interval to ensure that it always has the most recent encryption keys.

In step 230, an incoming voice call can be received by the subscriber network for a mobile device on the subscriber network. The incoming voice call may originate from another subscriber on the network. The incoming voice call may originate from a subscriber using plain old telephone service (POTS) that does not support encryption. The incoming voice call may originate from a mobile device on another network that does not implement encryption as contemplated by this invention. The incoming voice call may be received by the subscriber network as an analog audio transmission, an unencrypted digital communication, or a digital communication that is encrypted in accordance with an encryption algorithm negotiated between the subscriber network and the network of the caller.

In step 240, the incoming voice call is encoded as voice data packets. If the originating call is an analog call, the call can be digitally encoded with a digital to analog converter (DAC). The digital voice call data can be compressed using audio codecs. The digital voice call data can be packetized prior to transmission to the mobile device. In some embodiments, the incoming voice call is already digitized upon receipt by the subscriber network. In those embodiments, the encoding step 240 can be bypassed. Alternatively, the encoding step can transcode the received digital voice data in accordance with a packetization scheme implemented by the subscriber network. One packetization scheme may packetize call data in accordance with a reduced the maximum transfer unit (MTU) to make room for encryption header data and decrease fragmentation when sent over standard transmission protocols.

In step 250, the voice data packets of step 240 can be encrypted with the public key of the mobile device.

In step 260, the encrypted voice data packets can be sent to the mobile device. Data communications can be transmitted to a mobile phone through a hierarchical network architecture that routes packets from the core network to the specific cell where the mobile device is currently located. When the subscriber network prepares to transmit encrypted voice data packets to a mobile device, the network first determines the current location of the device through mobility management procedures maintained by the core network infrastructure.

In 4G LTE networks, the Mobility Management Entity (MME) tracks the location of each registered mobile device, while the Serving Gateway (S-GW) and Packet Data Network Gateway (P-GW) handle the routing of user plane data. When encrypted voice data packets are destined for a mobile device, the packets are routed from the P-GW through the S-GW to the eNodeB (base station) serving the cell where the mobile device is currently camped. The eNodeB then schedules radio resources for downlink transmission and transmits the packets over the air interface using the LTE radio protocols.

In 5G networks, the User Plane Function (UPF) handles packet routing, while the Access and Mobility Management Function (AMF) manages device location tracking. Encrypted voice data packets traverse the UPF and are delivered to the appropriate gNB (5G base station) for wireless transmission to the mobile device. The gNB allocates radio resources on the 5G New Radio interface and transmits the encrypted packets to the mobile device using the configured numerology and bandwidth allocation.

For mobile devices roaming on foreign networks, the data path extends through the roaming network infrastructure. The home subscriber network routes packets to the visited network through established roaming interconnection agreements, and the visited network's radio access infrastructure delivers the packets to the mobile device. Importantly, when embodiments of the present invention are employed, the voice data packets remain encrypted throughout this entire transmission path, including during transit through the roaming network infrastructure, thereby protecting the communications from interception by entities with access to the roaming network.

The mobile device can include software that is specially configured to receive, decrypt, reassemble, and playback encrypted voice data packets. The software can be a dedicated stand-alone app. Alternatively, the software can be integrated into the native call application of the mobile device so that incoming VoIP calls and other calls are received in a unified familiar interface. Portions of the software can be integrated into the operating system of the device.

In step 270, the mobile device decrypts the received encrypted voice data packets using the private key stored on the mobile device.

In step 280, the decrypted voice data packets are then assembled into a coherent voice data stream by reordering packets according to their sequence numbers and buffering packets in a jitter buffer to compensate for variations in packet arrival times.

In step 290, the assembled voice data stream is played through the audio output of the mobile device, such as the device speaker or connected audio accessories, allowing the mobile subscriber to hear the incoming voice communication.

The exemplary embodiment described in conjunction with FIG. 2 details the process steps of receiving a voice call by a mobile network, digitizing, packetizing, and encrypting the voice data, and sending the encrypted voice data to a mobile device. Those of skill in the art will appreciate, however, that a similar process can be used in reverse to send encrypted digital voice communications from the mobile device back to the mobile network.

In the reverse direction, when the mobile device user speaks into the device microphone, the analog voice signal is captured and converted to digital format by the mobile device's analog-to-digital converter. The mobile device then compresses the digital voice data using audio codecs and packetizes the compressed data into voice data packets suitable for transmission over the mobile network. Prior to transmission, the mobile device encrypts each voice data packet using the public key of the subscriber network, which may be stored locally on the mobile device or retrieved from the key database during call setup.

The encrypted voice data packets are transmitted from the mobile device over the air interface to the serving base station, which forwards the packets through the roaming network infrastructure, if applicable, to the subscriber network. Upon receipt by the subscriber network, the encrypted voice data packets are decrypted using the subscriber network's private key. The subscriber network then reassembles the decrypted voice data packets into a coherent voice stream and forwards the voice communication to the intended recipient, which may be another subscriber on the network, a subscriber on a different mobile network, or a party connected via the PSTN.

This bidirectional encryption scheme ensures that voice communications traveling between the mobile device and the subscriber network remain protected regardless of the direction of transmission. When the mobile device is roaming on a foreign network, both incoming and outgoing voice data packets traverse the roaming network infrastructure in encrypted form, preventing interception or eavesdropping by entities with access to the roaming network. The symmetric nature of the encryption process for both transmission directions provides comprehensive protection for the entire voice conversation during end-to-middle encrypted calls.

FIG. 3 is a flow chart of end-to-end encryption according to an exemplary embodiment of the invention. End-to-end encryption can be used when both calling devices implement encryption in accordance with the invention. FIG. 3 illustrates the process of generating encryption keys and sending encrypted call data to a first device (called device) from a second device (calling device).

As shown in FIG. 3, the process can commence in step 310 where a public key and private key is generated for the first mobile device. This process step can be the same as process step 210 discussed in conjunction with FIG. 2.

In step 320, the private key can be stored on the first mobile device. This process step can be the same as process step 220 discussed in conjunction with FIG. 2.

In step 330, a second mobile device can request the public key of the first mobile device. The public key of the first mobile device can be requested from the subscriber network of the first mobile device. The public key of the first mobile device can be requested from a third party key server. The public key of the first mobile device can be requested from cache or a local data store on the second mobile device.

In step 340, the second device can initiate a VoIP call to the first device. The initiation of a VoIP call between the second device and the first device can follow an established signaling protocol, such as utilizing the Session Initiation Protocol (SIP) for call setup and management. When the second device initiates the call, it can generate a SIP INVITE message containing the destination address of the first device, session description information specifying the proposed media parameters, and in embodiments of the present invention, cryptographic parameters for establishing the encrypted session.

The SIP INVITE message can be transmitted from the second device through the network infrastructure to the first device. In mobile network environments, the INVITE message can traverse the IP Multimedia Subsystem (IMS) infrastructure, passing through Proxy Call Session Control Functions (P-CSCF) and other SIP proxies that route the signaling to the appropriate destination. When the first device is roaming, the signaling path can extend through the roaming network infrastructure to reach the first device.

Upon receiving the SIP INVITE message, the first device can evaluate the session parameters and, if accepting the call, can respond with a SIP 200 OK message indicating acceptance of the call and confirming the negotiated session parameters. The second device can then transmit a SIP ACK message to complete the three-way handshake that establishes the call session.

During this signaling exchange, the devices can negotiate encryption parameters for the voice media stream. In embodiments of the present invention, the second device can include the public key of the first device in the session description or reference a previously retrieved public key to indicate that subsequent voice data packets will be encrypted using asymmetric encryption. Alternatively, the devices may use the initial asymmetric key exchange to establish a shared session key for symmetric encryption of the voice media, reducing computational overhead during the active call phase.

Once the SIP signaling completes and the call session is established, the Real-time Transport Protocol (RTP) can be used to carry the actual voice data packets between the devices. Each RTP packet containing voice data can be encrypted by the second device using the public key of the first device before transmission, ensuring that the voice content remains protected throughout the network path.

In step 350, the second device can digitize, packetize, and encrypt voice data packets to be sent to the first device. When the user of the second device speaks into the device microphone, the analog voice signal can be captured and converted to digital format through the device's analog-to-digital converter. The digital voice data can be compressed using audio codecs to reduce bandwidth requirements while maintaining acceptable voice quality for real-time communication.

The compressed digital voice data can be subsequently packetized into discrete voice data packets suitable for transmission over IP networks. Each packet can include header information containing source and destination addresses, sequence numbers for proper reassembly at the receiving end, and timing information to facilitate synchronization of the voice stream. The packetization process can utilize a reduced maximum transfer unit (MTU) to accommodate encryption overhead and minimize fragmentation during transmission.

Prior to transmission, each voice data packet can be encrypted using the public key of the first device that was retrieved in step 330. The encryption operation can transform the plaintext voice data into ciphertext that can only be decrypted by the holder of the corresponding private key, which is stored exclusively on the first device. This encryption ensures that the voice content remains protected throughout the entire network path, including any intermediate network segments, roaming network infrastructure, or potentially compromised network elements.

In step 360, the encrypted voice data packets are transmitted from the second device over the air interface to the serving base station. The base station forwards the encrypted packets through the network infrastructure toward the first device. When either device is roaming on a foreign network, the encrypted packets traverse the roaming network infrastructure while maintaining their encrypted state, preventing interception or eavesdropping by entities with access to the roaming network.

In step 370, the first device receives the encrypted voice data packets and decrypts them using the private key stored on the first device. The decryption operation recovers the original voice data packets from the encrypted ciphertext.

In step 380, the decrypted voice data packets are assembled into a coherent voice data stream by reordering packets according to their sequence numbers and buffering packets in a jitter buffer to compensate for variations in packet arrival times caused by network conditions.

In step 390, the assembled voice data stream is played through the audio output of the first device, such as the device speaker or connected audio accessories, allowing the user of the first device to hear the voice communication from the second device.

Those of skill in the art will appreciate that the illustrative embodiment of FIG. 3 can apply in reverse to send encrypted call data from the first device back to the second device. In the reverse direction, when the user of the first device speaks into the device microphone during the established call session, the analog voice signal is captured and converted to digital format by the first device's analog-to-digital converter. The first device compresses the digital voice data using audio codecs and packetizes the compressed data into voice data packets suitable for transmission over the mobile network. Prior to transmission, the first device encrypts each voice data packet using the public key of the second device, which may have been exchanged during the call setup signaling phase or retrieved from the subscriber network's key database.

The encrypted voice data packets are transmitted from the first device over the air interface to the serving base station, which forwards the packets through the network infrastructure toward the second device. When either device is roaming on a foreign network, the encrypted packets traverse the roaming network infrastructure while maintaining their encrypted state, ensuring that the voice content remains protected from interception by entities with access to intermediate network segments.

Upon receipt by the second device, the encrypted voice data packets are decrypted using the private key stored on the second device. The second device then reassembles the decrypted voice data packets into a coherent voice stream by reordering packets according to their sequence numbers and buffering packets in a jitter buffer to compensate for variations in packet arrival times. The assembled voice data stream is subsequently played through the audio output of the second device, allowing the user of the second device to hear the voice communication from the first device.

This bidirectional encryption scheme ensures that voice communications traveling between the first device and the second device remain protected regardless of the direction of transmission. Both incoming and outgoing voice data packets traverse all intermediate network infrastructure, including roaming networks, in encrypted form, preventing interception or eavesdropping by any entity along the transmission path. The symmetric nature of the encryption process for both transmission directions provides comprehensive end-to-end protection for the entire voice conversation, ensuring that only the intended recipient possessing the corresponding private key can decrypt and access the voice content.

Embodiments of the invention can be performed substantially by software. The software can be executed by one or more processors within network infrastructure components, including but not limited to servers, routers, gateways, mobility management entities, home subscriber servers, and other network elements. The software components implementing embodiments of the invention may be distributed across multiple network elements to perform the various functions described herein. On the mobile device side, software modules can be responsible for key generation, key storage and management, encryption and decryption operations, voice data packetization, and integration with the device's audio input and output subsystems. These software modules may be implemented as standalone applications, as extensions to existing VoIP or telephony applications, or as components integrated into the mobile device operating system.

Within the network infrastructure, software executing on subscriber network servers can manage the key database, handle key distribution requests, perform encryption and decryption operations for end-to-middle encryption scenarios, and coordinate signaling for encrypted call establishment.

The software may be stored in non-transitory computer-readable media, including but not limited to random access memory (RAM), read-only memory (ROM), flash memory, solid-state drives, magnetic storage devices, and optical storage media. The software may be distributed to network elements and mobile devices through various mechanisms, including firmware updates, over-the-air software updates, application store downloads, and network provisioning systems.

The processors executing the software may include general-purpose central processing units (CPUs), digital signal processors (DSPs) optimized for audio processing and cryptographic operations, application-specific integrated circuits (ASICs), field-programmable gate arrays (FPGAs), and specialized cryptographic co-processors designed to accelerate encryption and decryption operations. Mobile devices may utilize system-on-chip (SoC) architectures that integrate multiple processing elements capable of executing different aspects of the encryption and voice processing functions.

It will be apparent to those skilled in the art that various modifications and variations can be made in the method of encrypting VoIP communications without departing from the spirit or scope of the invention. Thus, it is intended that embodiments of the invention cover the modifications and variations of this invention provided they come within the scope of the appended claims and their equivalents.

What is claimed is:

1. A method for encrypting voice calls to a mobile device, the method comprising:
generating a public key and a private key associated with a mobile subscriber;
storing the private key on a mobile device of the mobile subscriber;
receiving, by a mobile network, a voice call for the mobile subscriber;
generating an encrypted voice data packet by encrypting a voice data packet with the public key;
sending the encrypted voice data packet to the mobile device; and
decrypting the encrypted voice data packet using the private key device to yield the voice data packet.

2. The method of claim 1 further comprising:
assembling the voice data packet and a plurality of other voice data packets to create a voice data stream; and
playing the voice data stream on the mobile device.

3. The method of claim 1 wherein the voice call originates from a telephone network that is different from the mobile network.

4. The method of claim 1 further comprising:
generating a session key;
sharing the session key between the mobile network and the mobile device; and
wherein the session key is used for symmetric encryption of the voice call.

5. The method of claim 1 wherein the voice call originates from the PTSN.

6. The method of claim 1 wherein the mobile device is connected to a roaming network and the sending of the encrypted voice data packet includes traversing the roaming network.

7. The method of claim 6 wherein the voice data packet is encrypted through the full transmission path between the mobile network to the mobile device.

8. The method of claim 1 further comprising:
receiving call audio from the mobile device;
digitizing and packetizing the call audio;
encrypting the packetized call audio with a public key of the mobile network;
sending the encrypted packetized call audio to the mobile network;
decrypting the encrypted packetized call audio by the mobile network; and
sending the unencrypted packetized call audio to a second device.

9. A method for encrypting voice calls between a first mobile device and a second mobile device, the method comprising:
generating a public key and a private key associated with the first mobile device;
storing the private key on a mobile device of the mobile subscriber;
requesting, by a second mobile device, the public key;
initiating, by the second mobile device, a digital voice call with the first mobile device;
generating an encrypted voice data packet from an unencrypted voice data packet of the digital voice call using the public key;
sending the encrypted voice data packet to a mobile network by the second mobile device;
sending the encrypted voice data packet to the first mobile device by the mobile network; and
decrypting the encrypted voice data packet using the private key on the first mobile device.

10. The method of claim 9 wherein a transmission path between the mobile network and the first mobile device includes a roaming network and wherein the encrypted voice data packet is encrypted with the public key of the first mobile device while the encrypted voice data packet is within the roaming network.

11. The method of claim 9 further comprising:
Generating, on the first mobile device, a second encrypted voice data packet from a second unencrypted voice data packet using the public key of the second mobile device;
sending the second encrypted voice data packet to the mobile network by the first mobile device;
sending the second encrypted voice data packet to the second mobile device by the mobile network;
receiving, but the second mobile device, the second encrypted voice data packet; and
decrypting the second encrypted voice data packet using a private key of the second mobile device on the second mobile device.

12. The method of claim 9 the generating of the public key and the private key occurs during initial provisioning of the mobile device on the mobile network.

13. The method of claim 9 further comprising storing the public key in a key database maintained by the mobile network.

14. The method of claim 9 wherein the voice data packet is encrypted using a hybrid encryption scheme comprising:
generating a symmetric session key;
encrypting the voice data packet with the symmetric session key;
encrypting the symmetric session key with the public key; and
transmitting the encrypted symmetric session key with the encrypted voice data packet.

15. The method of claim 9 wherein the first mobile device and the second mobile device are subscribers of a same subscriber network.

16. The method of claim 9 wherein the first mobile device is a subscriber of a first subscriber network and the second mobile device is a subscriber of a second subscriber network different from the first subscriber network.

17. The method of claim 9 wherein the mobile network passes the encrypted voice data packet to the first mobile device without decrypting the encrypted voice data packet.

18. The method of claim 9 wherein both the first mobile device is connected a roaming network that is different from a roaming network of the second mobile device and wherein the encrypted voice data packet remains encrypted while traversing both roaming networks.

19. A method for encrypting voice calls between a subscriber network and a mobile device connected to a roaming network, the method comprising:
receiving, by the subscriber network, a voice call for the mobile device;
packetizing the voice call into a plurality of unencrypted data packets;
encrypting the unencrypted data packets into a plurality of encrypted data packets using a private key of the mobile device;
sending the plurality of encrypted data packets to the roaming network;
receiving, by the mobile device, the plurality of encrypted data packets;
decrypting, but the mobile device, the plurality of encrypted data packets into a decrypted plurality of data packets using a private key of the mobile device; and
assembling the decrypted plurality of data packets into a voice data stream.

20. The method of claim 19 further comprising:
generating, by the mobile device, a plurality of responsive voice data packets;
encrypting, by the mobile device, the plurality of responsive voice data packets into a plurality of encrypted responsive voice data packets using a public key of the subscriber network;
sending the plurality of encrypted responsive voice data packets to the roaming network;
receiving, by the subscriber network, the plurality of encrypted responsive voice data packets; and
decrypting, by the subscriber network, plurality of encrypted responsive voice data packets into a decrypted plurality of responsive data packets using a private key of the subscriber network.
